(19) United States
(12) Patent Application Publication
(10) Pub. No.: US 2002/0103871 A1
(43) Pub. Date: Aug. 1, 2002

(54) Method and apparatus for natural language processing of electronic mail

(75) Inventor: James D. Pustejovsky, Arlington, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LingoMotors, Inc., Cambridge, MA

(21) Appl. No.: 09/954,623

(22) Filed: Sep. 12, 2001

Related U.S. Application Data
(60) Provisional application No. 60/231,889, filed on Sep. 11, 2000.
(60) Provisional application No. 60/236,509, filed on Sep. 29, 2000.

(51) Int. Cl. G06F 15/16

(52) U.S. Cl. 709/206

(57) ABSTRACT

A technique for accessing electronic mail (e-mail) messages includes populating a database with the e-mail and segments of text comprising the e-mail. The segments of text are associated with lexical types, thereby producing plural lexical elements. Access is based on a search of the lexical types. The query upon which the access is based is segmented into lexical elements and the database is accessed based on the lexical elements derived from the query.

### CROSS-REFERENCES TO RELATED APPLICATIONS

This application is a nonprovisional of and claims priority to each of the following applications, the entire disclosures of which are herein incorporated by reference for all purposes: U.S. Prov. Appl. No. 60/231,889 by James D. Pustejovsky, filed Sep. 11, 2000 entitled “METHOD AND APPARATUS FOR NATURAL LANGUAGE PROCESSING OF ELECTRONIC MAIL” and U.S. Prov. Appl. No. 60/236,509 by John O'Neill, filed Sep. 29, 2000 entitled “SEARCH ENGINE METHOD AND SYSTEM.”

The following commonly owned previously filed applications are hereby incorporated by reference in their entirety for all purposes:

U.S. Prov. Appl. No. 60/110,190 by James D. Pustejovsky et al., filed Nov. 30, 1998, entitled “A NATURAL KNOWLEDGE ACQUISITION METHOD, SYSTEM, AND CODE”;

U.S. Prov. Appl. No. 60/163,345 by James D. Pustejovsky et al., filed Nov. 3, 1999, entitled, “A METHOD FOR USING A KNOWLEDGE ACQUISITION SYSTEM”;

U.S. Prov. Appl. No. 60/191,883 by James D. Pustejovsky, filed Mar. 23, 2000, entitled, “RETURNING DYNAMIC CATEGORIES IN SEARCH AND QUESTION-ANSWER SYSTEMS”;

U.S. Prov. Appl. No. 60/197,011 by James D. Pustejovsky, filed Apr. 13, 2000, entitled, “ANSWERING VERBAL QUESTIONS USING A NATURAL LANGUAGE SYSTEM”;

U.S. Prov. Appl. No. 60/226,413 by James D. Pustejovsky et. al, filed Aug. 18, 2000, entitled, “TYPE CONSTRUCTION AND THE LOGIC OF CONCEPTS”;

U.S. Prov. Appl. No. 60/228,616 by James D. Pustejovsky et. al, filed Aug. 28, 2000, entitled, “ANSWERING USER QUERIES USING A NATURAL LANGUAGE METHOD AND SYSTEM”;

U.S. Prov. Appl. No. 60/232,051 by James D. Pustejovsky, filed Sep. 12, 2000 entitled “NATURAL LANGUAGE”;

U.S. application Ser. No. 09/449,845 by James D. Pustejovsky et al, filed Nov. 26, 1999, entitled “A NATURAL KNOWLEDGE ACQUISITION SYSTEM”;

U.S. application Ser. No. 09/433,630 by James D. Pustejovsky et al., filed Nov. 26, 1999, entitled, “A NATURAL KNOWLEDGE ACQUISITION METHOD”;

U.S. application Ser. No. 09/449,848 by James D. Pustejovsky et al,. filed Nov. 26, 1999, entitled, “A NATURAL KNOWLEDGE ACQUISITION SYSTEM COMPUTER CODE”;

U.S. application Ser. No. 09/662,510 by Robert J. P. Ingria et al., filed Sep. 15, 2000, entitled “ANSWERING USER QUERIES USING A NATURAL LANGUAGE METHOD AND SYSTEM”;

U.S. application Ser. No. 09/663,044 by Federica Busa et al., filed Sep. 15, 2000, entitled “NATURAL LANGUAGE TYPE SYSTEM AND METHOD”;

U.S. application Ser. No. 09/742,459 by James D. Pustejovsky et al., filed Dec. 19, 2000, entitled “METHOD FOR USING A KNOWLEDGE ACQUISITION SYSTEM”;

U.S. application Ser. No. 09/898,987 by Marcus E. M. Verhagen et al., filed Jul. 3, 2001, entitled “METHOD AND SYSTEM FOR ACQUIRING AND MAINTAINING NATURAL LANGUAGE INFORMATION”; and

U.S. application Ser. No.______ by James D. Pustejovsky et al., filed concurrently herewith, entitled “NATURAL LANGUAGE SEARCH METHOD AND SYSTEM FOR ELECTRONIC BOOKS” (Attorney Docket No. 19497-000610US).

### BACKGROUND OF THE INVENTION

This invention generally relates to the field of information management. More particularly, the present invention provides a method and system for natural language processing of electronic mail.

Electronic mail or “e-mail”, as it is widely known, refers to messages that are sent from one computer user to another over interconnected computer networks. Computer systems that support e-mail facilitate such message transfer by providing a means for composing messages, transferring them from the message originator to the intended recipient, notifying the recipient and reporting to the originator upon message receipt, and placing messages in the proper format for transmission over the networks.

Early e-mail systems comprised terminal-to-terminal message transfer between users at a common computer site, or between users at different computer sites who used common data processing equipment. For example, some early e-mail systems used simple file transfer protocols for intra-network communication specifying predefined message header data fields that identified originators and recipients with respective network terminal nodes, followed by message text. Many modern e-mail systems support information types including ASCII text, analog facsimile (fax) data, digital fax data, digital voice data, videotext, and many others.

The expansion of the Internet has greatly facilitated the accessibility of e-mail by the general public. Whereas e-mail in its early days was a tool available primarily in academic circles, e-mail has since become as ubiquitous as the telephone. Users include students, professionals, homemakers, and other private sector groups. Commercial enterprises use e-mail to hawk their goods over the Internet. E-mail represents a valuable source of information. E-mail messages are directed messages that contain information that is usually relevant to the recipient. Even advertisements might at some time become relevant, since it behooves the advertiser to accurately target her buying public.

Consequently, the mass of e-mail messages that can accumulate over time needs to be managed. E-mail readers are programs which provide e-mail functionality, such as composing e-mail and sending e-mail. E-mail readers typically provide some form of management capability to organize the plethora of e-mail messages one can accumulate over time; however, typically only the most primitive capabilities are implemented. Third party Internet companies are beginning to offer remote storage capacity, one step closer to a diskless PC, where data is stored at a remote disk server. An immediate consequence of this seemingly unlimited storage capacity is that e-mail can be saved and later used as a data source. Effective information retrieval will then become paramount in order to take advantage of the mountain of information that can be contained in e-mail messages.

Recent improvements in speech recognition and speech synthesis can be used to provide a more user-friendly and streamlined interface to access information. The user simply speaks the commands to perform searching and the system can “speak” back the results. However, the use of a voice/text interface still requires that textual information be properly managed and accessible to get a useful result.

From the above, it is seen that a technique which provides relevant answers to a user's natural language question in connection with searching through e-mail, for example as provided by a verbal query, is highly desirable. There is a need for a sophisticated search capability in order to effectively and efficiently sort through e-mail messages.

### SUMMARY OF THE INVENTION

In accordance with the invention a method and system to access electronic mail (e-mail) includes storing the e-mail in a database. The e-mail is processed to yield one or more segments of text which comprise the email. Each segment is associated with a lexical type. This information is stored in the database along with the e-mail.

In another aspect of the invention, the database is queried to obtain one or more e-mail messages. The query is processed to produce one or more segments and the search is based on these one or more segments of the query.

In yet another aspect of the invention, the e-mail messages are further processed to identify related categories to which the e-mail messages are associated. In this aspect of the invention, the database is further queried to identify additional e-mail messages based on the related categories.

One of the many advantages over the prior art is increasing the probability that the user's query is correctly answered. Another is using a remote device to ask and receive answers verbally using a natural language processing system.

### BRIEF DESCRIPTION OF THE DRAWINGS

The teachings of the present invention can be readily understood by considering the following detailed description in conjunction with the accompanying drawings:

FIG. 1 illustrates a simplified network architecture of a specific embodiment of the present invention;

FIG. 2 is a simplified block diagram of the natural language component shown in FIG. 1; and

FIG. 3 shows a simplified flowchart for a specific embodiment of the present invention.

### DESCRIPTION OF THE SPECIFIC EMBODIMENTS

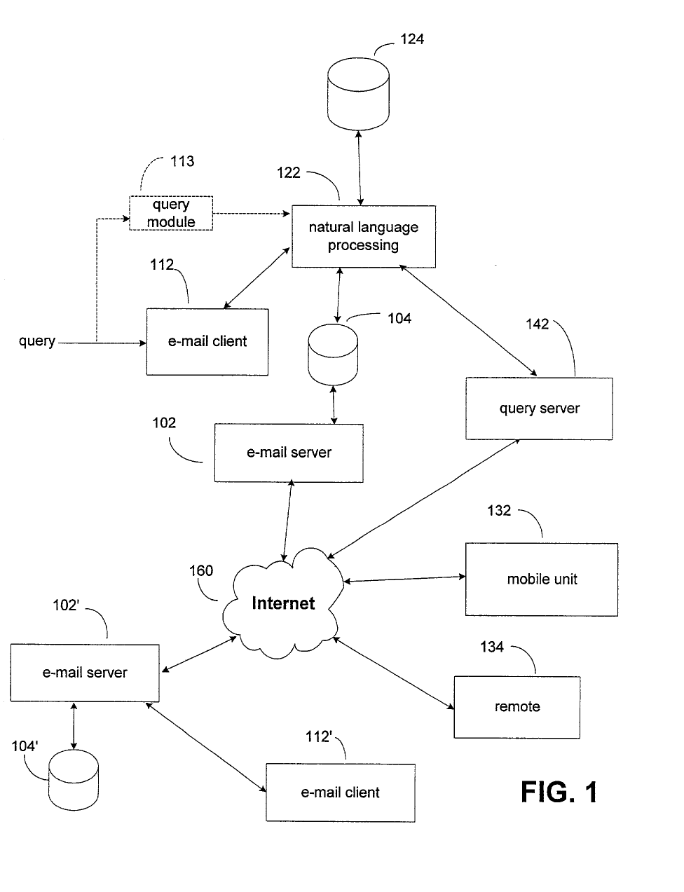

FIG. 1 illustrates a simplified network architecture of a specific embodiment of the present invention. Users send and receive electronic mail via e-mail servers 102, 102′ through e-mail clients 112, 112′. Each e-mail server typically has a data store 104, 104′ for storing and retrieving messages. E-mail is transmitted over a communication network 160, such as the Internet. The communication network can be a locally provided network, a privately maintained intranet, or the like.

The e-mail client is typically an e-mail reader which interacts with the e-mail server to access stored e-mail message, such as for example, the Eudora e-mail client from Qualcomm, Inc. However, the e-mail client may be an email-enabled application, the primary function of which is not mail but which requires mail access services. In one embodiment of the invention, for example, an e-mail interface is provided in a voice-text conversion application. Such an application facilitates accessing e-mail using a voice interface. The e-mail interface is provided by any of a number of known API's (application programming interfaces); for example, VIM (vendor independent messaging), CMC (common mail calls), and MAPI (messaging API).

The architecture shown in FIG. 1 further includes a natural language processing component 122 which is coupled to data store 104. As will be discussed below, e-mail messages received and stored by e-mail server 102 are processed by the natural language processing component. The results of the processing are stored in a database 124.

In accordance with embodiments of the present invention, e-mail client 112 interfaces with the natural language processing component via a suitable API. Further in accordance with embodiments of the invention, the e-mail client includes a query handling component to provide an interface by which e-mail messages can be searched and retrieved per the invention. Alternatively, the query handling component can be provided as a separate module 113, as shown in FIG. 1 in phantom lines. However, it may be preferable to include the query module into the e-mail reader 112, in order to provide a full-featured e-mail reader with the retrieval capability of embodiments of the present invention. The specific implementation and partitioning of the functional elements shown in FIG. 1 will depend on marketing and other such considerations.

The e-mail client 112 shown in FIG. 1 can be implemented in software which resides in a conventional personal computer. FIG. 1 also shows another aspect of the invention in which the e-mail client resides in a device other that a personal computer. A generic remote unit 132 is shown which can be an email client having an API for accessing natural language processing component 122, or interfacing with a query server 142. For example, the e-mail client function can be provided in a mobile unit 134, such as for example, a cell phone, laptop computer having a wireless modem, or a personal digital assistant (PDA), in which the user inputs a verbal or textual question. The mobile unit 132 communicates via a wireless link over the Internet to the query server, or alternatively directly to the query server.

A verbal interface can be provided. Commercial software, for example, Dragon NaturallySpeaking® from Dragon Systems of Newton, MA or IBM's ViaVoice for Apple Computer's Macintosh® personal computer, may be used to convert a verbal question into its textual form, and vice-versa. Thus, remote unit 132 may include a voice/text conversion component, for example such as described in U.S. Provisional Patent Application No. 60/197,011 in the names of James D. Pustejovsky titled, “Answering Verbal Questions Using A Natural Language System,” filed Apr. 13, 2000.

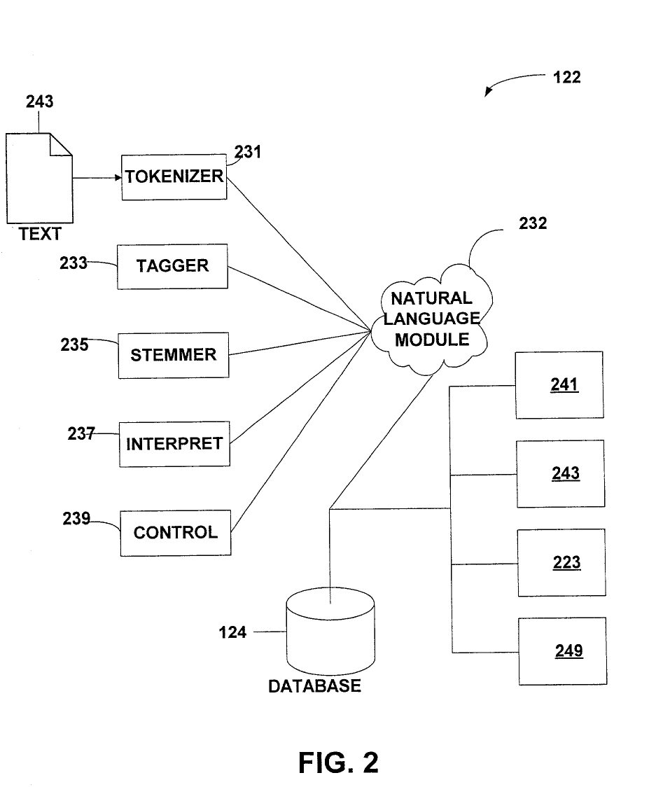

FIG. 2 is a simplified block diagram of the natural language processing component 122 according to an embodiment of the present invention. The diagram is merely an illustration and should not limit the scope of the claims herein. One of ordinary skill in the art would recognize many other variations, modifications, and alternatives. As shown, the natural language processing component 122 includes a common bus, which couples together various elements. The elements include a microprocessor device 241, a temporary memory 243, a network interface device 223, an input/output interface 249, and various software modules, which define a natural language software engine 232.

The engine 232 includes a tokenizer 231, which is adapted to receive a stream of text information comprising the e-mail messages. The tokenizer separates the stream of text information into plural segments of text referred to as tokens. Tokens may comprise a single word, or groups of words. The engine also includes a tagger 233 coupled to the tokenizer that is adapted to tag each token. A stemmer 235 coupled to the tagger also is included. The stemmer is adapted to stem each of the tagged tokens. The interpreter is coupled to the stemmer. The segments of text are associated with lexical types to produce a plurality of lexical elements.

An interpreter 237 is adapted to form an object including syntactic information and semantic information from each of the stemmed, tagged, tokens. The engine also has control 239, which couples to the other elements. The natural language processing component 122 is coupled to database 124. The database is a relational or objected oriented or mixed database. The engine is adapted to form a knowledge base from the stream of text information 243. The knowledge base has a plurality of objects that populate the database. These include entity objects, properties (or attributes) of objects, and relations between objects.

The engine is adapted to retrieve from the knowledge base an answer to a query by the user. Here, the query can be in the form of text 243. The processing of a query is fully discussed in U.S. Prov. Appl. No. 60/228,616, which has been incorporated herein by reference.

In another specific embodiment of the present invention a list of relevant documents in response to a user query is returned. These documents may be ranked according to relevance, and also categorized dynamically into relevant classifications and sub-classifications, as motivated (or directed) by the content of a query. These “related categories” allow for a more natural and intuitive navigability of the document set returned by a query than conventional search technologies allow. The related categories are not static or pre-defined labels assigned to documents, but are computed dynamically as the result of two steps:

1. The e-mail messages are processed by the natural language processing system and relevant entities and relations are stored in the database as discussed above and more fully in commonly owned U.S. application Ser. No. 09/449,845, which has been incorporated herein by reference in its entirety.

2. The query is processed by the natural language processing component 122 and the entities and relations are represented in a normalized logical form.

The semantic form (normalized logical form) for the query is matched against the database; both exact matches (if present) and dynamically computed related categories are returned. A further description is given in U.S. Prov. Appl. Nos. 60/163,345 and 60/191,883, both of which have been incorporated herein by reference.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

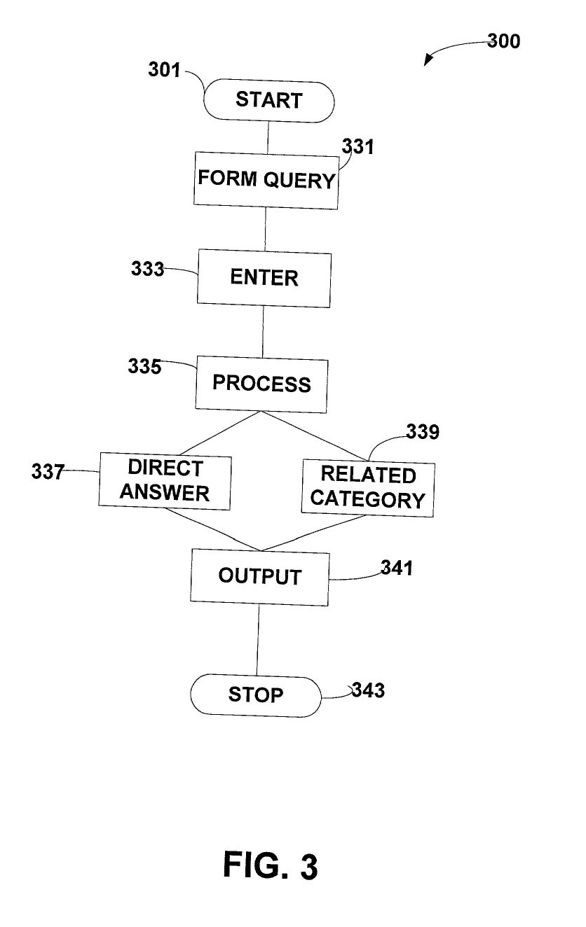

FIG. 3 is a simplified flow diagram 300 of a method according to an embodiment of the present invention. The diagram is merely an illustration and should not limit the scope of the claims herein. One of ordinary skill in the art would recognize many other variations, modifications, and alternatives. As shown, the method begins at block 301. Here, the natural language processing component 122 receives a query (block 331), which is formed, from the user. The query is made by a user input device, e.g., electronic pen, keyboard, microphone. In a specific embodiment, the query is provided in textual form, which is entered, block 333. The textual query is sent to the natural language processing component were the query is processed (block 335). In a specific embodiment, two different forms of answers are provided by the natural language system: direct answer(s) to the query (block 337) and related categories to the query (block 339). The direct answer(s), block 337, is sent back to the user, block 341, from the database to a display. If related categories (block 339) are provided, then they may be sent in textual form from the database to a display. The user could then select to view sub-categories or documents. In another embodiment, the related categories may be given in verbal rather than textual form and the user may select a sub-category or document via verbal command and have, for example, the document read to her/him.

The following example illustrates how the user may use one embodiment of the present invention. Merely as an example, suppose that a series of e-mail messages relating to current news events are received. A user might ask by way of a keyboard-entered query, or a verbal query: “What did the S&P stock index do?.” In the case of a verbal question, the query would first be converted into its textual form, i.e., “What did the S&P stock index do?,” and sent to the natural language processing component 122. This text-form query would go through the stages including the forgoing tagging and tokenization steps to yield:

What/WP did/VBD the/DT S&P500/NNP stock/NN index/NN do/VB?/

and would produce a semantic representation of the following form:

[UtteranceLexLF
type: [[Question]]
illocutionaryForce: #WhQuestion
content: [FunctionLexLF

type: [[QueryDo]]
predicateStem: ‘do’
complements: (#Subject -> [EntityLexLF

type: [[Abstract Object]]
value: ‘S&P500 stock index’
quantification: [QuantifierLexLF

type: [[Abstract Object]]
value: ‘The’]]

#DirectObject -> [EntityLexLF

type: [[Entity]]
value: ‘What’
quantification: [QuantifierLexLF

type: [[Entity]]
value: ‘what’
quantifier: #Wh]])]]

There are several features of this semantic form. First, the semantics of the interrogative pronoun ‘What’ is interpreted in its ‘logical’ position, i.e. as the direct object of the main verb ‘do’. Second, the semantic representation of ‘What’ includes a QuantifierLexLF that has #Wh as the value of its #quantifier. This indicates that this is the logical argument that is being asked about in this query.

Semantic representations for content queries of this type are processed for database lookup in the following manner:

First, the EntityID of the subject is retrieved:

select EntityID from Entities where CanonicalName=‘S&P500 stock index’

This will retrieve the EntityID 5230, which is then used to construct a select statement on the Relations table:

select * from Relations where Subject=5230

This will retrieve the row:

(776,23,405,380,5230,null,5231,‘36.46’,0,0,null,0,null,0,null,0)

Finally, for presentation to the user, the system will use this information to retrieve the sentence:

The S&P500 stock index rose 36.46 points.

That is, the sentence at offset position 380, in the document with DocumentID 405, whose filename is ‘0000077400’. This information is passed in the format:

<DISPLAY-FULL-OBJECT ““
{ “Reuters”
“http://199.103.231.59/demo-

code/source.pl/display=0000077400,380#380”

“The S&P500 stock index rose 36.46 points.” } { } >

which contains the source of the response text, an address that points to the complete source document, and the actual response text.

The natural language system may retrieve the complete source document of the given address and pass both the answer to the query (“What did the S&P stock index do?”), i.e., “The S&P500 stock index rose 36.46 points,” as well the complete source document text to a server, which contains the full source information. The server would then convert the answer from text to voice and the user would hear on a speaker: “The S&P500 stock index rose 36.46 points.” Alternatively, the text could be displayed. The user could be prompted to request the e-mail source of the information with a prompt such as: “If you want to hear the complete source of the answer, press #.” If the user then presses “#,” the server would then convert the source text to voice and send it to the user.

The above embodiments illustrate an embodiment of a natural language system that may be used in responding to voice or text from a remote user with a wireless connection, an Internet telephone user, a landline telephone user, or the like. Other embodiments of natural language systems that may be used in the present invention are described in U.S. Pat. No. 5,794,050 in the names of Dahlgren et al., LexiGuide products, e.g., Web or Surfer or Expert, of LexiQuest, Inc, Ask Jeeves, Inc. question and answering product, vReps of Neuromedia, Inc., ALife-SmartEngine of Artificial Life, Inc., and the like.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. For example, a voice query could be for directions to the closest Italian Restaurant or the nearest hospital that accepts Blue Cross Insurance. Therefore, it is to be understood that within the scope of the appended claims, the invention may be practiced otherwise than as specifically described.

What is claimed is:

1. A method for accessing one or more electronic mail (e-mail) messages from among plural e-mail messages, comprising:
accessing a database comprising said e-mail messages and lexical elements based on said e-mail messages; and
selecting one or more database entries by searching said lexical elements to produce said one or more e-mail messages.

2. The method of claim 1 further including receiving a query, said searching being based on said query.

3. The method of claim 2 wherein said query is in natural language logic form.

4. The method of claim 2 wherein said lexical elements have associated lexical types, said searching being further based on searching said lexical types.

5. The method of claim 1 wherein said lexical elements in said database have associated lexical types; the method further including receiving a query and segmenting said query into one or more lexical elements; said searching being based on said lexical elements of said query.

6. The method of claim 5 wherein said query is in text-form and said segmenting includes producing plural segments of text and associating each segment of text with a lexical type.

7. The method of claim 1 wherein said lexical elements in said database have associated lexical types, the method further including:
receiving a query;
segmenting said query into one or more lexical elements; and
associating each lexical element with a lexical type,
said searching being based on matching lexical types in said query with lexical types in said database.

8. The method of claim 1 further including converting a voice-based input to a text-based query, said searching being based on said text-based query.

9. The method of claim 8 further including converting said one or more e-mail messaged to a voice-based output.

10. A system for accessing electronic mail (e-mail) messages comprising:
an e-mail input module configured to receive input data and to produce an e-mail message comprising a text stream;
a text analyzer configured to receive said text stream and to segment said text stream into one or more lexical elements;
a data store configured to receive said text stream and to receive said lexical elements;
a user input device configured to receive user input and to produce a query; and
an output device,
said text analyzer further configured to receive said query,
said text analyzer further configured to retrieve portions of text contained in said data store based on said query,
said text analyzer coupled to said output device to deliver said portions of text.

11. The system of claim 10 wherein said text analyzer is further configured to produce objects, each object corresponding to a portion of said text stream, each object having an associated lexical type.

12. The system of claim 11 wherein said data store is a relational object oriented database.

13. The system of claim 10 wherein said e-mail input module is incorporated in an application program.

14. The system of claim 13 wherein said application program is an e-mail reader.

15. The system of claim 10 wherein said user input device includes a voice-to-text conversion module, wherein voice input is converted to text to produce said query.

16. The system of claim 15 wherein said output device includes a text-to-voice conversion module.

17. The system of claim 10 wherein said data store is a relational database.

18. The system of claim 10 wherein said text analyzer includes a tokenizer to produce plural segments of text from said text stream and to associate tokens with said segments of text.

19. The system of claim 18 wherein said text analyzer further includes a tagger to produce a tagged token by associating a tag with each token.

20. The system of claim 19 wherein said text analyzer further includes a stemmer to produce a stem for each said tagged token.

21. A method for processing electronic mail (e-mail) messages comprising:
receiving an e-mail message comprising text;
segmenting said e-mail message into one or more lexical elements;
associating each lexical element with a lexical type; and
storing said e-mail message and said lexical elements in a database.

22. The method of claim 21 further including identifying related categories based on syntactic or semantic information contained in said e-mail messages and associating said related categories to said e-mail messages.

23. The method of claim 21 further including repeating the foregoing steps for additional e-mail messages.

24. The method of claim 21 wherein said receiving an e-mail includes receiving an e-mail in an application program.

25. The method of claim 24 wherein said application program is an e-mail reader.

26. The method of claim 21 further including receiving a query and retrieving said lexical elements from said database as a response to said query.

27. The method of claim 26 wherein said retrieving said lexical elements includes associating segments of said query with said lexical elements.

28. The method of claim 26 wherein said query is a natural language query.

29. The method of claim 26 wherein said receiving a query includes receiving voice input and applying voice recognition to said voice input to produce said query.

30. The method of claim 29 further including converting said response to voice.

31. The method of claim 21 further including forming plural objects, each object being associated with one of said lexical elements.

32. The method of claim 31 further including storing said objects in a relational database.

33. The method of claim 21 wherein said segmenting includes tagging said lexical elements to produce plural tags, said associating being based on said tags.

34. The method of claim 33 wherein said segmenting further includes stemming said lexical elements to produce plural stems, said associating further being based on said stems.

35. The method of claim 34 further including tokenizing said text to produce said lexical elements.

36. A computer program product for accessing electronic mail (e-mail) messages, the computer program product comprising:
code for receiving an e-mail message comprising a text stream;
code for segmenting said text stream into one or more lexical elements;
code for storing said text stream and said lexical elements in a database;
code for receiving a query;
code for retrieving information from said database based on said query; and
a computer-readable medium for storing said codes.
